(19) United States
(12) Patent Application Publication
(10) Pub. No.: US 2012/0212817 A1
(43) Pub. Date: Aug. 23, 2012

(54) SELF HEATABLE INSPECTION MIRROR

(76) Inventor: Robert Craig Moore, Fish Creek (AU)

(21) Appl. No.: 13/208,375

(22) Filed: Aug. 12, 2011

(30) Foreign Application Priority Data
Feb. 17, 2011 (AU) 2011200672

(51) Int. Cl. G02B 7/18

(52) U.S. Cl. 359/512

(57) ABSTRACT

A self heating inspection mirror for dental use has a pencil like handle with an angled mirror. A resistance wire heating coil is surrounded by wafers of insulation and lies in contact with the mirror. Leads pass down the handle to a plug and socket. The socket is in the battery compartment which allows the operator to unplug the handle and immerse the mirror and handle as a unit. The battery compartment has an integral switch for connecting the battery to the heating coil The 3V rechargeable lithium battery maintains the lightweight mirror at 43EC.

### FIELD OF THE INVENTION

This invention concerns self heatable inspection mirrors. Such mirrors called stomatoscopes are used by dentists to look inside the mouth of a patient.

### BACKGROUND OF THE INVENTION

It is well known that the efficiency of such mirrors is spoiled by fogging once the patients moist breath condenses on the cold mirror. The dentist must wipe away the moisture film every time it appears and interrupts vision. Attempts to build a heated mirror have not resulted in an instrument which has a slim pencil like handle for gripping by the operator. If batteries are housed in the handle itself, even small AAA batteries result in an instrument which obstructs access to the mouth by drills, syringes and other equipment.

Operators prefer to handle the instrument between thumb and forefinger with the rear part of the instrument resting on the Thenor Web of the palm.

U.S. Pat. No. 6,702,577 shows an instrument which heats the mirror itself by directing light from an LED on to the mirror. This allows button cells to supply the voltage required. While this allows a slim handle and a detachable battery container, the use only of incident radiation to heat the mirror means that the instrument takes time to reach and pass the dew point.

U.S. Pat. No. 4,568,281 describes a low weight instrument with a slim handle which requires only 0.35 watts to keep the mirror at 32-37EC. A resistor of 1650 ohms allows a current of about 15 milliamps at 24V to posistors in the casing of the instrument which houses the mirror. This voltage is supplied through leads which pass out of the handle to an external power source. Accordingly the instrument is captive and liable to be an impediment in that sense to dental procedures.

Heated mirrors for dental work have therefore been replaced by instruments which stay at room temperature but do not fog because the mirror is dipped in a liquid sterilising solution which also contains a silicone. This inhibits surface deposition of water below dew point.

U.S. Pat. No. 5,181,848 shows an instrument with a hemispherical cup which contains a light source which emits light from an annular window which surrounds the mirror. Heat from the light source heats the mirror somewhat.

### SUMMARY OF THE INVENTION

This invention provides a self heatable inspection mirror for dental use, comprising a handle with a head end and a battery end, a hollow head connected to the head end, a mirror sealed edgewise within the hollow head, a wire resistor heating element accommodated in the head in thermal exchange with the mirror, conductor leads connected between the element and the battery end, a detachable battery container removably connected to the battery end and electrical contacts in the container operable to connect with the conductor leads when the container is connected to the handle.

In a preferred embodiment the handle exceeds the length of an operators fingers so that in use the battery container lies rearwardly to the operators hand. The handle is 140-180 mm in length and is of reduced cross-section at the head end.

The handle cross-section at the battery end is circular and about 5 mm in diameter.

The battery end and the battery container share a plug and socket connection for allowing detachment of the battery container and enabling immersion sterilisation of the handle and head.

The element is laminated between an inner and outer layer of insulation and the mirror contacts the outer layer.

The battery container accommodates a single 3V dry cell battery and the steady temperature of the mirror is 37-43EC.

The battery container has an external switch for connecting the battery when fitted to the plug and socket connection.

The battery end of the handle and the battery container have coaxially overlapping parts allowing push fit connection and the parts in turn surround the plug and socket.

### BRIEF DESCRIPTION OF THE DRAWINGS

One embodiment of the invention is now described with reference to the accompanying drawings, in which:

FIG. 1 is a diagrammatic section of a self heating mirror according to the invention.

FIG. 2 is a plan of the heating element.

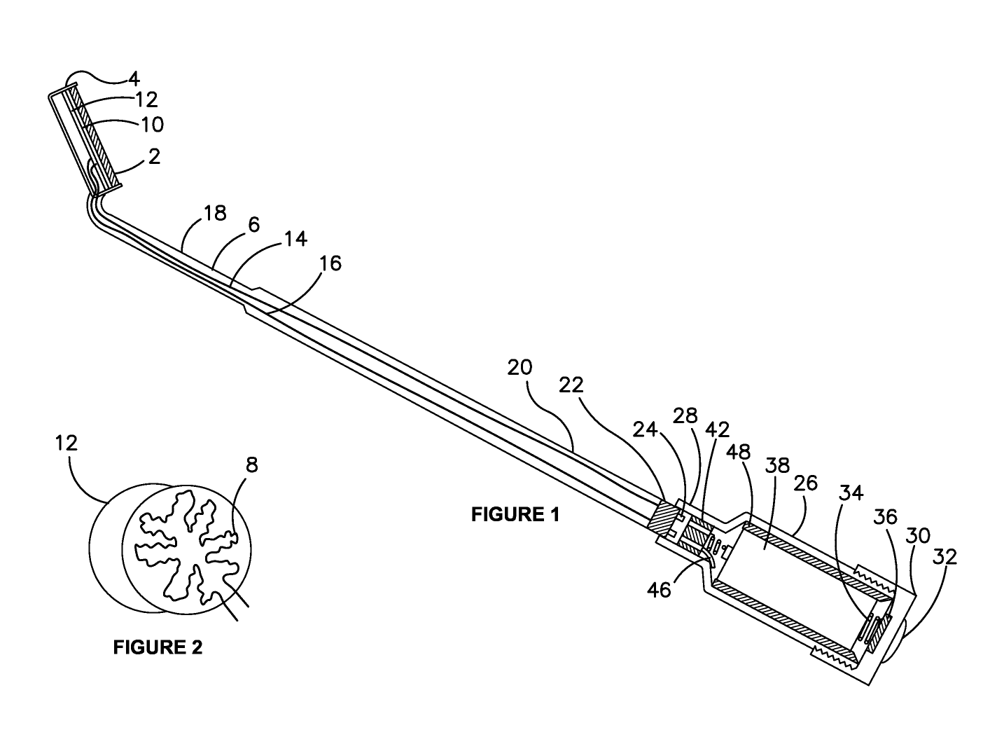

### DETAILED DESCRIPTION WITH RESPECT TO THE DRAWINGS

Referring now to the drawings, 22 mm dia. flat glass mirror 2 is sealed at its edge to a shallow stainless steel mirror tray 4. The tray is soldered to the mirror end of tubular handle 6. Between the rear face of the mirror and the tray 4 is a wire resistance heating element 8 made from zinc aluminium alloy wire sandwiched between two thin, circular wafers of insulation 10, 12. Wafer 12 is in contact with the rear face of mirror 2.

Element 8 joins leads 14, 16 which run along tubular stainless steel handle 6. The distal end 18 is 4.7 mm in dia. The proximal end 20 of the handle is 6 mm in dia. and all together the handle is 150 mm long. The end of the proximal part of the handle receives a sealed plug 22 of male configuration and the plug pins 24 connect with the leads 14, 16. This handle with the integral mirror is waterproof and can be immersed in antiseptic liquid if required.

The battery compartment 26 is a stainless steel tube 60 mm long with a neck 28 at the open end and an exterior thread at the opposite end for reception of a removable screw-on stainless steel cap 30 which incorporates a known diaphragm switch 32. Helical spring 34 is attached to switch plate 36 and urges battery 38 forwards to meet coil spring 40 which connects with female socket 42. Socket 42 is secured in neck 28 by adhesive. Battery 38 is a 3V 1800 mAH rechargeable lithium battery sold under the GTL® brand. The proximal end of the handle is a push fit into neck 28 and presents the plug 22 to the socket 42 so that lead 14 can reach the pole of the battery while the battery casing allows voltage to pass via the switch 32 into compartment tube 26 and from the tube via soldered connector 46 to socket 42. Battery sleeve 48 insulates the battery from the tube 26.

In use the operator heats the mirror by pushing handle end 20 into neck 28 and by activating the switch 32 which allows the mirror 2 to reach its target temperature of 43EC. The handle is long enough to be held like a pen.

I have found the advantages of the above embodiment to be:

1. Good access to the site of inspection when used as a dental mirror.

2. Lightweight.

3. Economical to build and run.

It is to be understood that the word “comprising” as used throughout the specification is to be interpreted in its inclusive form, ie. use of the word “comprising” does not exclude the addition of other elements.

It is to be understood that various modifications of and/or additions to the invention can be made without departing from the basic nature of the invention. These modifications and/or additions are therefore considered to fall within the scope of the invention.

The claims defining the invention are as follows:

1. A self heatable inspection mirror for dental use, comprising a handle with a head end and a battery end, a hollow head connected to the head end, a mirror sealed edgewise within the hollow head, a wire resistor heating element accommodated in the head in thermal exchange with the mirror, conductor leads connected between the element and the battery end, a detachable battery container removably connected to the battery end and electrical contacts in the container operable to connect with the conductor leads when the container is connected to the handle.

2. A self heatable inspection mirror as claimed in claim 1, wherein the handle exceeds the length of an operators fingers so that in use the battery container lies rearwardly to the operators hand.

3. A self heatable inspection mirror as claimed in claim 2, wherein the handle is 140-180 mm in length.

4. A self heatable inspection mirror as claimed in claim 1, wherein the handle is of reduced cross-section at the head end.

5. A self heatable inspection mirror as claimed in claim 4, wherein the handle cross-section at the battery end is circular and about 5 mm in diameter.

6. A self heatable inspection mirror as claimed in claim 1, wherein the battery end and the battery container share a plug and socket connection for allowing detachment of the battery container and enabling immersion sterilisation of the handle and head.

7. A self heatable inspection mirror as claimed in claim 1, wherein the element is laminated between an inner and outer layer of insulation and the mirror contacts the outer layer.

8. A self heatable inspection mirror as claimed in claim 6, wherein the battery container accommodates a single 3V dry cell battery and the steady temperature of the mirror is 37-43EC.

9. A self heatable inspection mirror as claimed in claim 6, wherein the battery container has an external switch for connecting the battery when fitted to the plug and socket connection.

10. A self heatable inspection mirror as claimed in claim 6, wherein the battery end of the handle and the battery container have coaxially overlapping parts allowing push fit connection and the parts in turn surround the plug and socket.
